(19) United States
(12) Patent Application Publication
(10) Pub. No.: US 2024/0169018 A1
(43) Pub. Date: May 23, 2024

(54) MATRIX MULTIPLIER IMPLEMENTED TO PERFORM CONCURRENT STORE AND MULTIPLY-ACCUMULATE (MAC) OPERATIONS

(71) Applicant: QUALCOMM Incorporated, San Diego, CA (US)

(72) Inventors: Hamza OMAR, San Diego, CA (US); Engin IPEK, San Diego, CA (US); Bohuslav RYCHLIK, San Diego, CA (US); Luca MARONCELLI, Cambridge (GB)

(21) Appl. No.: 17/989,448

(22) Filed: Nov. 17, 2022

(51) Int. Cl. G06F 17/16; G06F 7/544

(52) U.S. Cl. CPC G06F 17/16; G06F 7/5443

(57) ABSTRACT

An apparatus, including: a memory; a matrix multiplier engine, comprising: an array of multiplier-accumulate units (MAUs) comprising: a first set of accumulators; and a second set of accumulators; and a controller configured to concurrently: cause a first set of resultant values in the first set of accumulators to be transferred to the memory pursuant to a first set of store instructions, wherein the first set of resultant values was generated pursuant to a first set of multiply-accumulate (MAC) operations performed by the set of multipliers and the first set of accumulators; and cause the set of multipliers and the second set of accumulators to perform a second set of MAC operations.

### FIELD

Aspects of the present disclosure relate generally to matrix multipliers, and in particular, to a matrix multiplier implemented to perform concurrent store and multiply-accumulate (MAC) operations.

### BACKGROUND

Matrix multiplier processors or engines are useful for performing different types of matrix and/or vector multiplications for various applications. For example, matrix multiplier engines may be employed to perform machine learning (ML) operations, image processing, facial feature extraction, object detection, speech-to-text processing, etc. As these types of data processing devices are continually being improved for speed and operation efficiencies, it is of interest to improve matrix multiplier engines for higher speeds and operation efficiencies.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to an apparatus, including: a memory; a matrix multiplier engine coupled to the memory, comprising: an array of multiplier-accumulate units (MAUs) comprising: a first set of accumulators; and a second set of accumulators; and a controller coupled to the matrix multiplier engine and the memory, the controller configured to concurrently: cause a first set of resultant values in the first set of accumulators to be transferred to the memory pursuant to a first set of store instructions, wherein the first set of resultant values was generated pursuant to a first set of multiply-accumulate (MAC) operations performed by the set of multipliers and the first set of accumulators; and cause the set of multipliers and the second set of accumulators to perform a second set of MAC operations.

Another aspect of the disclosure relates to a method of performing matrix multiplication. The method includes transferring a first set of resultant values from a first set of accumulators to a memory, wherein the first set of resultant values were generated from a first set of multiply-accumulate (MAC) operations; and performing a second set of MAC operations using a second set of accumulators concurrently with the transferring of the first set of resultant values from the first set of accumulators to the memory.

Another aspect of the disclosure relates to an apparatus, including: means for transferring a first set of resultant values from a first set of accumulators to a memory, wherein the first set of resultant values were generated from a first set of multiply-accumulate (MAC) operations; and means for performing a second set of MAC operations using a second set of accumulators concurrently with the transferring of the first set of resultant values from the first set of accumulators to the memory.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1A illustrates a block diagram of an example matrix multiplier engine in accordance with an aspect of the disclosure.

FIG. 1B illustrates a block diagram of an example matrix multiplier system in accordance with another aspect of the disclosure.

FIG. 1C illustrates a block diagram of an example multiplier-accumulator unit (MAU) in accordance with another aspect of the disclosure.

FIG. 1D illustrates a sequential diagram of an example set of instructions for operating a matrix multiplier system in accordance with another aspect of the disclosure.

FIG. 2A illustrates a block diagram of another example multiplier-accumulator unit (MAU) in accordance with another aspect of the disclosure.

FIG. 2B illustrates a sequential diagram of another example set of instructions for operating a matrix multiplier system in accordance with another aspect of the disclosure.

FIG. 2C illustrates a flow diagram of an example method of concurrently storing a set of values resulting from a previous set of multiply-accumulate (MAC) operations and performing a current set of MAC operations in accordance with another aspect of the disclosure.

FIG. 3A illustrates a block diagram of another example multiplier-accumulator unit (MAU) in accordance with another aspect of the disclosure.

FIG. 3B illustrates a sequential diagram of another example set of instructions for operating a matrix multiplier system in accordance with another aspect of the disclosure.

FIG. 3C illustrates a flow diagram of another example method of concurrently storing a set of values resulting from a previous set of multiply-accumulate (MAC) operations and performing a current set of MAC operations in accordance with another aspect of the disclosure.

FIG. 4 illustrates a block diagram of an example multi-core integrated circuit (IC) including a matrix multiplier engine in accordance with another aspect of the disclosure.

FIG. 5 illustrates a flow diagram of an example method of performing matrix multiplication in accordance with another aspect of the disclosure.

FIG. 6 illustrates a block diagram of an example apparatus for performing matrix multiplication in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

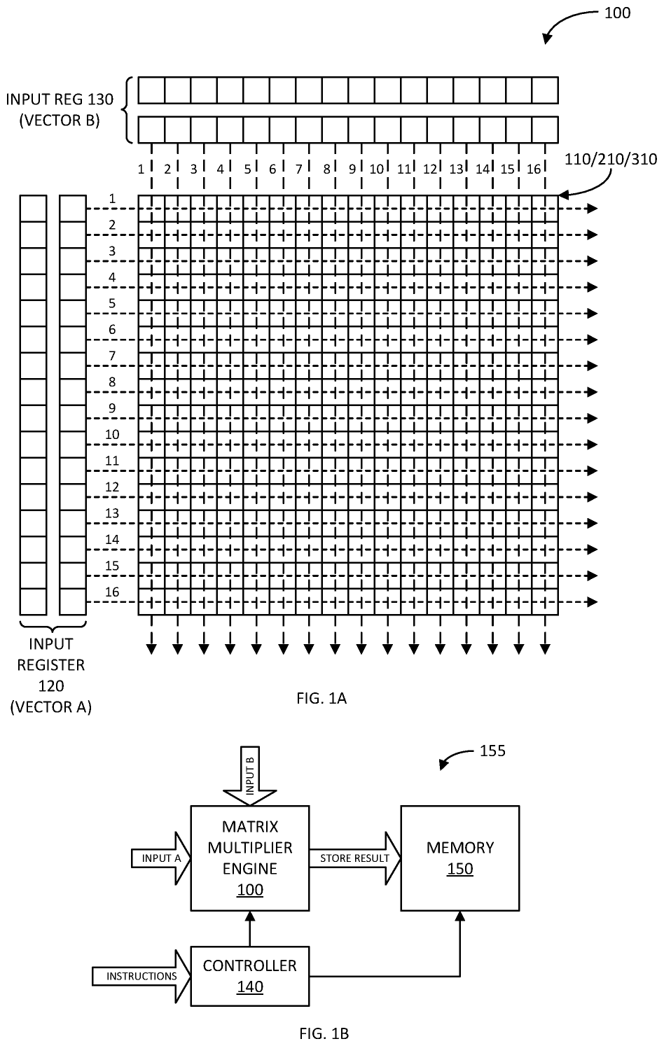

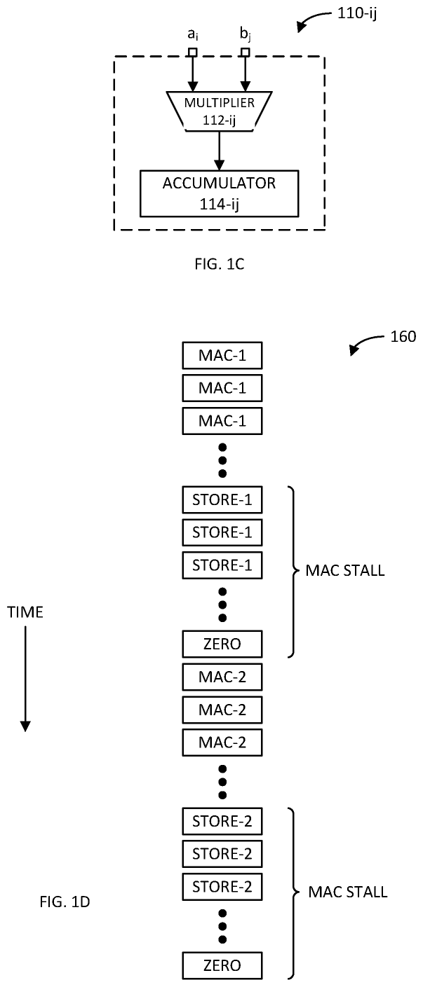

FIG. 1A illustrates a block diagram of an example matrix multiplier processor or engine 100 in accordance with an aspect of the disclosure. The matrix multiplier engine 100 includes a multi-dimensional (e.g., two-dimensional) array of multiplier-accumulator units (MAUs) 110/210/310 (e.g., a 16×16 MAU array, but could be of a different dimension, and may be a single-dimensional array or more than two-dimensional array). The matrix multiplier engine 100 further includes a first set of one or more cascaded input registers 120 for providing a set of input vectors “A” to rows of the two-dimensional array of MAUs 110/210/310. Similarly, the matrix multiplier engine 100 further includes a second set of one or more cascaded registers 130 for providing a set of input vectors “B” to columns of the two-dimensional array of MAUs 110/210/310.

FIG. 1B illustrates a block diagram of an example matrix multiplier system 155 in accordance with another aspect of the disclosure. The matrix multiplier system 155 includes the matrix multiplier engine 100, an associated controller 140, and a memory 150. The matrix multiplier engine 100 is configured to sequentially receive a set of input vectors A and a set of input vectors B, and its array of MAUs 110/210/310 is configured to perform a set of MAC operations (via the corresponding sets of multipliers 112 and accumulators 114) based on a set of MAC instructions executed by the controller 140. Once the array of MAUs 110/210/310 completes the set of MAC operations, and the resulting values are held in the set of accumulators 114, the controller 140 may cause the resulting values in the set of accumulators 114 to be stored or transferred (e.g., row-by-row or column-by-column) to the memory 150 based on executing a set of store instructions.

FIG. 1C illustrates a block diagram of an example multiplier-accumulator unit (MAU) 110-ij in accordance with another aspect of the disclosure. The MAU 110-ij may be an example implementation of the MAU in the i^{th} row and j^{th} column of the two-dimensional array of MAUs 110. All other MAUs of the array 110 may be similarly implemented. The MAU 110-ij includes a multiplier 112-ij and an accumulator 114-ij. The multiplier 112-ij includes inputs to receive an operand aᵢ from input vector A and an operand bⱼ from input vector B. The multiplier 112-ij is configured to multiply the operands aᵢ and bⱼ, and additively store the resulting value or product (aᵢ×bⱼ) in the accumulator 114-ij. Each of these operations may be referred to as a multiply-accumulate (MAC) operation or a matrix outer product (MOP) operation. The set of multipliers and accumulators of the array of MAUs 110 may be referred generally as the set of multipliers 112 and the set of accumulators 114.

FIG. 1D illustrates a sequential diagram of an example set of instructions 160/260/360 for operating the matrix multiplier engine 100 in accordance with another aspect of the disclosure. The vertical axis of the sequential diagram represents time. The set of instructions 160 are provided to the controller 140 for controlling the operations of the matrix multiplier engine 100 and the memory 150.

In particular, the set of instructions 160 includes a first set of MAC instructions (referred to individually as MAC-1). The first set of MAC instructions instructs at least a subset of the array of MAUs 110 to perform a first set of MAC operations based on first sets of input vectors A and B.

After the first set of MAC operations, the set of instructions 160 includes a first set of store instructions (referred to individually as STORE-1). The first set of store instructions instructs the matrix multiplier engine 100 to store or transfer the resultant values (as a result of the first set of MAC operations) in the set of accumulators 114 (e.g., via row-by-row or column-by-column) of the array of MAUs 110 to the memory 150. Note that during the storing operation, the array of MAUs 110 do not perform MAC operations; in other words, the MAC operations are stalled as the set of accumulators 114 are being used for storing purposes.

After the first set of store instructions, the set of instructions 160 includes a zero instruction to zero, clear, or reset the set of accumulators 114 of the array of MAUs 110. The zero instruction may indicate that the following MAC operations (MAC-2) performed by the array of MAUs 110 is independent of the MAC operations pursuant to the first set of MAC instructions (MAC-1).

Then, the set of instructions 160 includes a second set of MAC instructions (referred to individually as MAC-2). The second set of MAC instructions instructs another at least subset of the array of MAUs 110 to perform the second set of MAC operations based on second sets of input vectors A and B. As mentioned, the second set of MAC operations (MAC-2) may be independent of the first subset of MAC operations (MAC-1).

Similarly, after the second set of MAC operations (MAC-2), the set of instructions 160 includes a second subset of store instructions (referred to individually as STORE-2). The second set of store instructions (STORE-2) instructs the matrix multiplier engine 100 to store or transfer the resultant values (as a result of the second set of MAC operations) in the set of accumulators 114 (e.g., via row-to-row or column-to-column) of the array of MAUs 110 to the memory 150. Again, during the storing operation, the MAC operations performed by the array of MAUs 110 are stalled. After the second set of store instructions (STORE-2), the set of instructions 160 includes another zero instruction to zero, clear, or reset the set of accumulators 114 of the array of MAUs 110.

As indicated, the MAC operations being stalled during the store operations produces inefficiency in the operation of the matrix multiplier engine 100.

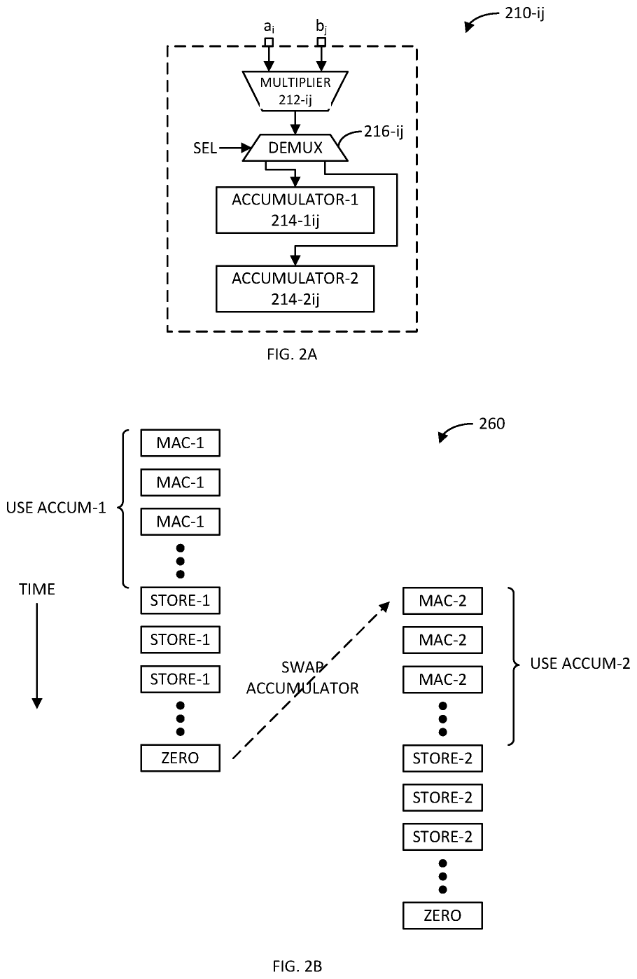

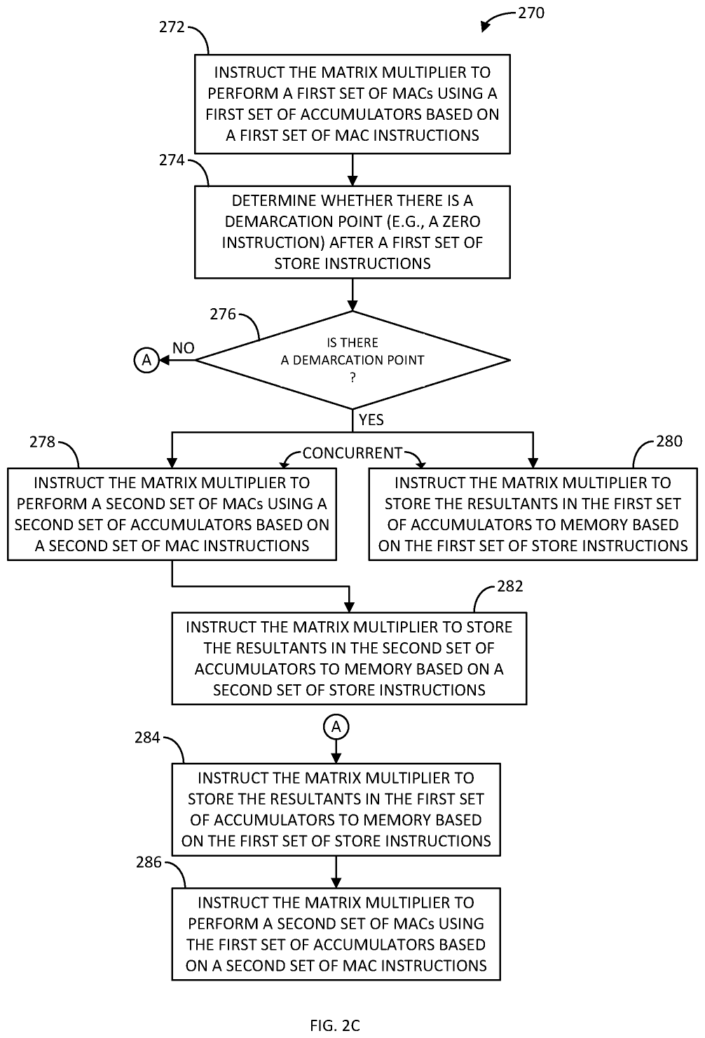

FIG. 2A illustrates a block diagram of another example multiplier-accumulator unit (MAU) 210-ij in accordance with another aspect of the disclosure. Similarly, the MAU 210-ij may be an example implementation of the MAU in the i^{th} row and j^{th} column of a newly-designed two-dimensional array of MAUs 210 for the matrix multiplier engine 100. All other MAUs of the array 210 may be similarly implemented.

The MAU 210-ij includes a multiplier 212-ij, a pair of accumulators 214-1ij (−1) and 214-2ij (−2) (e.g., two (2) in this example, but could be more as discussed further herein), and a demultiplexer 216-ij. The multiplier 212-ij includes inputs to receive operand aᵢ from input vector A and operand bⱼ from input vector B. The multiplier 212-ij is configured to multiply the operands aᵢ and bⱼ, and additively store the resulting value or product (aᵢ×bⱼ) in the “active” one of the pair of accumulators 214-1ij and 214-2ij via the demultiplexer 216-ij. Similarly, each of these operations may be referred to as a multiply-accumulate (MAC) operation or a matrix outer product (MOP) operation.

More specifically, the output of the multiplier 212-ij is coupled to an input of the demultiplexer 216-ij. The demultiplexer 216-ij includes first and second outputs coupled to the pair of accumulators 214-1ij and 214-2ij, respectively. The demultiplexer 216-ij includes a select input configured to receive a control signal (SEL) from the controller 140 to select which of the pair of accumulators 214-1ij and 214-2ij is active. The set of multipliers, accumulators, and demultiplexers of the array of MAUs 210 may be referred generally as the set of multipliers 212, the set of accumulators 214, and the set of demultiplexers 216.

As discussed in more detail below, through the use of multiple accumulators per MAU, the stalling of the MAC operations as discussed with reference to the set of instructions 160 may be eliminated; thus, making the operation of the matrix multiplier engine 100 with an array of MAUs 210 substantially more efficient.

FIG. 2B illustrates a sequential diagram of another example set of instructions 260 for operating the matrix multiplier system 100 in accordance with another aspect of the disclosure. Similarly, the vertical axis of the sequential diagram represents time. Further, vertically downward and horizontally rightward indicate the sequential order of the set of instructions 260. The set of instructions 260 may include a first set of MAC instructions (referred to individually as MAC-1). The first set of MAC instructions (MAC-1) instructs at least a subset of the array of MAUs 210 to perform a first set of MAC operations based on first sets of input vectors A and B. Note that, in this example, the “active” set of accumulators for the first set of MAC operations is accumulators-1 (e.g., the set of accumulators 214-1) of MAUs of the array 210 (as selected by the controller 140 via the SEL control signal).

After the first set of MAC instructions (MAC-1), the set of instructions 260 includes a first set of store instructions (referred to individually as STORE-1). The first set of store instructions (STORE-1) instructs the matrix multiplier engine 100 to store or transfer the resultant values (as a result of the first set of MAC operations) in the first set of accumulators-1 214-1 (e.g., via row-by-row or column-by-column) of the array of MAUs 210 to the memory 150.

Note that, in this example, the controller 140 looks ahead to determine whether there is a first zero instruction after the first set of store instructions (STORE-1), and uses it as a demarcation point or instruction to zero, clear, or reset the “inactive” accumulator-2 (214-2, in this example), make the “inactive” accumulator-2 (214-2) as the new “active” accumulator, and designate accumulator-1 (214-1) as the “inactive” or “storing” accumulator. The aforementioned operation may be referred to as an accumulator swap or renaming. Then, the controller 140 may initiate the at least subset of the array of MAUs 210 to perform a second set of MAC operations (based on a second set of MAC instructions MAC-2) concurrently with the matrix multiplier engine 100 executing the first set of store instructions (STORE-1) to transfer the resultant values in the inactive set of accumulators-1 (214-2) to the memory 150.

Thus, in this example, MAC operations are not stalled, and the operation of the matrix multiplier engine 100 including the newly-designed MAUs 210 is significantly more efficient compared to the one including MAUs 110, as previously discussed.

FIG. 2C illustrates a flow diagram of an example method 270 of concurrently storing a set of values resulting from a previous set of multiply-accumulate (MAC) operations and performing a current set of MAC operations in accordance with another aspect of the disclosure. According to the method 270, the controller 140 instructs/causes the matrix multiplier engine 100 to perform a first set of MAC operations using a first set of accumulators (e.g., accumulators 214-1) based on a first set of MAC instructions (block 272).

The method 270 further includes the controller 140 determining whether there is a demarcation point or instruction (e.g., a zero instruction) after a first set of store instructions (block 274). For example, the demarcation point or instruction may be sequentially situated between the first set of store instructions and a second set of MAC instructions. If, in block 276, the controller 140 determines that there is a demarcation point or instruction after the first set of store instructions (meaning that the following MAC operations are independent of the previous MAC operations), the controller 140 instructs/causes the matrix multiplier engine 100 to perform a second set of MAC operations using a second set of accumulators (e.g., accumulators 214-2) based on a second set of MAC instructions (block 278). Also, concurrently with the matrix multiplier engine 100 performing the second set of MAC operations per block 278, the controller 140 instructs/causes the matrix multiplier engine 100 to store or transfer the resultant values in the first set of accumulators (e.g., accumulators 214-1) to the memory 150 based on the first set of store instructions (block 280). The method 270 further includes the controller 140 instructing/causing the matrix multiplier engine 100 to store or transfer the resultant values in the second set of accumulators (e.g., accumulators 214-2) to the memory 150 based on a second set of store instructions (block 282).

If, in block 276, the controller 140 determines that there is no demarcation point after the first set of store instruction (e.g., in other words, there is a second set of MAC instructions after the first set of store instructions without an intervening zero instruction), then the second set of MAC instructions depend on the first set of MAC instructions. In such case, the controller 140 instructs/causes the matrix multiplier engine 100 to store or transfer the resultant values in the first set of accumulators (e.g., accumulators 214-1) to the memory 150 based on the first set of store instructions (block 284). Then, the controller 140 instructs the matrix multiplier engine 100 to perform a second set of MAC operations using the first set of accumulators (e.g., accumulator 214-1) based on a second set of MAC instructions (block 286).

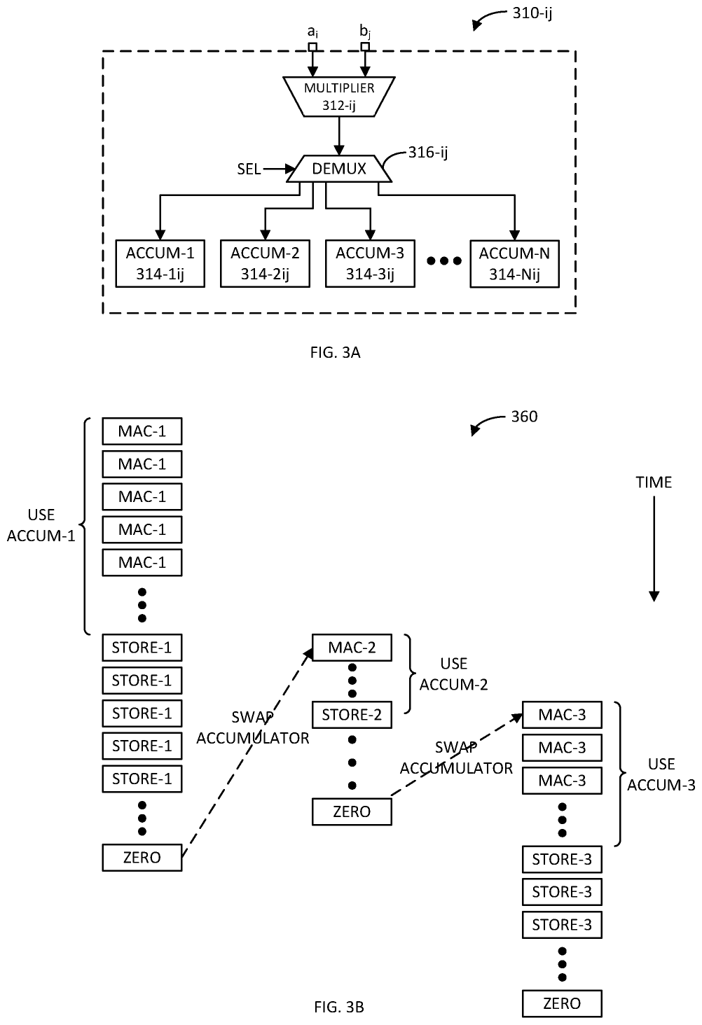

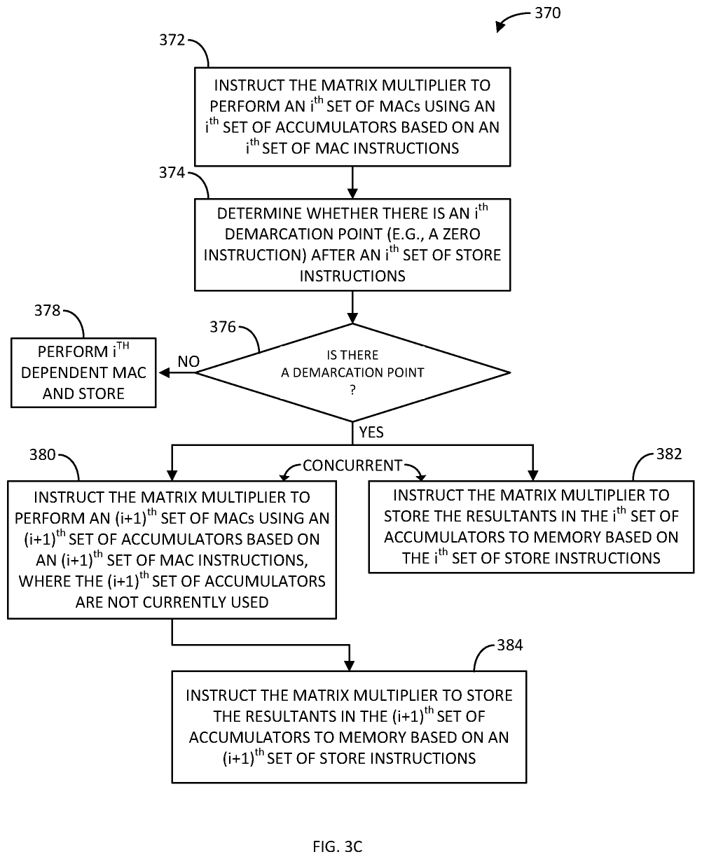

FIG. 3A illustrates a block diagram of another example multiplier-accumulator unit (MAU) 310-ij in accordance with another aspect of the disclosure. Similarly, the MAU 310-ij may be an example implementation of the MAU in the i^{th} row and j^{th} column of a newly-designed two-dimensional array of MAUs 310 for the matrix multiplier engine 100. All other MAUs of the array 310 may be similarly implemented.

The MAU 310-ij includes a multiplier 312-ij, a set of accumulators 314-1ij (−1) to 314-Nij (−N) (where N is an integer of 2 or more), and a demultiplexer 316-ij. The multiplier 312-ij includes inputs to receive operand aᵢ from input vector A and operand bⱼ from input vector B. The multiplier 312-ij is configured to multiply the operands aᵢ and bⱼ, and additively store the resulting value or product (aᵢ×bⱼ) in the “active” one of the set of accumulators 314-1ij to 314-Nij. Similarly, each of these operations may be referred to as a multiply-accumulate (MAC) operation or a matrix outer product (MOP) operation.

More specifically, the output of the multiplier 312-ij is coupled to an input of the demultiplexer 316-ij. The demultiplexer 316-ij includes a set of outputs coupled to the set of accumulators 314-1ij to 314-Nij, respectively. The demultiplexer 316-ij includes a select input configured to receive a control signal (SEL) from the controller 140 to control which of the set of accumulators 314-1ij to 314-Nij is active. The set of multipliers, accumulators, and demultiplexers of the array of MAUs 310 may be referred generally as the set of multipliers 312, the set of accumulators 314, and the set of demultiplexers 316. Similarly, through the use of multiple accumulators per MAU, the stalling of the MAC operations as discussed with reference to the set of instructions 160 may be eliminated; thus, making the operation of the matrix multiplier engine 100 with an array of MAUs 310 substantially more efficient.

FIG. 3B illustrates a sequential diagram of another example set of instructions 360 for operating the matrix multiplier engine 100 in accordance with another aspect of the disclosure. Similarly, the vertical axis of the sequential diagram represents time. Further, vertically downward and horizontally rightward indicate the sequential order of the set of instructions 360. The set of instructions 360 may include a first set of MAC instructions (referred to individually as MAC-1). The controller 140, in response to the first set of MAC instructions, instructs/causes at least a subset of the array of MAUs 310 to perform a first set of MAC operations based on first sets of input vectors A and B. Note that, in this example, the “active” accumulator for the first set of MAC operations is 314-1 (accumulator-1) of the array of MAUs 310 (as selected by the controller 140 via the SEL control signal).

After the first set of MAC instructions (MAC-1), the set of instructions 360 includes a first subset of store instructions (referred individually as STORE-1). The controller 140, in response to the first subset of store instructions (STORE-1), instructs/causes the matrix multiplier engine 100 to store or transfer the resultant values in the set of “storing” accumulators 314-1 (e.g., via row-by-row or column-by-column) of the array of MAUs 310 to the memory 150.

Note that, in this example, the controller 140 looks ahead for the first zero instruction, and uses it as a demarcation point or instruction to zero, clear, or reset an inactive accumulator (e.g., accumulator-2 or 314-2), makes the inactive accumulators (e.g., accumulator-2 or 314-2) as the new “active” accumulators (and the previous active accumulators-1 or 314-1 as the “storing” accumulator). The aforementioned operation may be referred to as an accumulator swap or renaming. The controller 140 then initiates the at least subset of the array of MAUs 310 to perform a second set of MAC operations (referred to individually as MAC-2) concurrently with the matrix multiplier engine 100 executing the first set of store instructions (STORE-1) to transfer the values in the “storing” accumulators-1 or 314-1 to the memory 150.

After the second set of MAC instructions (MAC-2), the set of instructions 360 includes a second subset of store instructions (referred individually as STORE-2). The second subset of store instructions (STORE-2) instructs the matrix multiplier engine 100 to store or transfer the resultant values in the set of “storing” accumulators (e.g., accumulator-2 or 314-2) (e.g., via row-by-row or column-by-column) of the array of MAUs 310 to the memory 150.

Note that, in this example, the matrix multiplier engine 100 looks ahead for the second zero instruction, and uses it as a demarcation point or instruction to zero, clear, or reset another inactive accumulator (e.g., accumulators-3 or 314-3), makes the another inactive accumulators-3 or 314-3 as the new “active” accumulator (and the previous active accumulator-2 or 314-2 as the “storing” accumulator). Again, the aforementioned operation may be referred to as an accumulator swap or renaming. The controller 140 then initiates the at least subset of the array of MAUs 310 to perform a third set of MAC operations (referred to individually as MAC-3) concurrently with the matrix multiplier engine 100 still executing the first subset of store instructions (STORE-1) to transfer the values in the storing accumulators-1 or 314-1 to the memory 150.

This is the reason there may be more than two accumulators because the first set of storing operations may not be complete when the third subset of MACs are executed. Accordingly, the first accumulator-1 cannot be used for the third subset of MACs as it is currently used for storing. Similarly, the second accumulator-2 cannot be used as it holds the values associated with the second subset of MAC operations to be stored or transferred to memory 150 after completion of the first set of store instructions.

FIG. 3C illustrates a flow diagram of an example method 370 of concurrently storing a set of values resulting from a previous set of multiply-accumulate (MAC) operations and performing a current set of MAC operations in accordance with another aspect of the disclosure. According to the method 370, the controller 140 instructs/causes the matrix multiplier engine 100 to perform an i^{th} set of MAC operations using an i^{th} set of accumulators (e.g., accumulators-1 or 314-1) based on an i^{th} set of MAC instructions (block 372).

The method 370 further includes the controller 140 determining whether there is a demarcation point or instruction (e.g., a zero instruction) after an i^{th} set of store instructions (block 374). For example, the demarcation instruction may be sequentially between the i^{th} set of store instructions and the (i+1)^{th} set of MAC instructions. If, in block 376, the controller 140 determines that there is a demarcation point after the i^{th} set of store instructions (meaning that the following MAC operations are independent of the previous MAC operations), the controller 140 instructs/causes the matrix multiplier engine 100 to perform an (i+1)^{th} set of MAC operations using an unused (i+1)^{th} set of accumulators (e.g., accumulator-2 or 314-2) based on an (i+1)^{th} set of MAC instructions (block 380). The newly-selected (i+1)^{th} set of accumulators is unused because it is not being currently used for MAC operations, for storing operations, or holds values to be stored or transferred to the memory 150.

Also, concurrently with the matrix multiplier engine 100 performing the (i+1)^{th} set of MAC operations per block 380, the controller 140 instructs/causes the matrix multiplier engine 100 to store or transfer the resultant values in the i^{th} set of accumulators (e.g., accumulator-1 or 314-1) to the memory 150 based on the i^{th} set of store instructions (block 382). The method 370 further includes the controller 140 instructing/causing the matrix multiplier engine 100 to store or transfer the resultant values in the (i+1)^{th} set of accumulators to the memory 150 based on an (i+1)^{th} set of store instructions (block 384).

If, in block 376, the controller 140 determines that there is no demarcation point after the i^{th} set of store instructions (e.g., in other words, there is an (i+1)^{th} set of MAC instructions after the i^{th} set of store instructions without an intervening zero instruction), then the (i+1)^{th} set of MAC instructions depend on the i^{th} set of MAC instructions. In such case, the controller 140 instructs the matrix multiplier engine 100 to perform the dependent MAC and store operations (block 378).

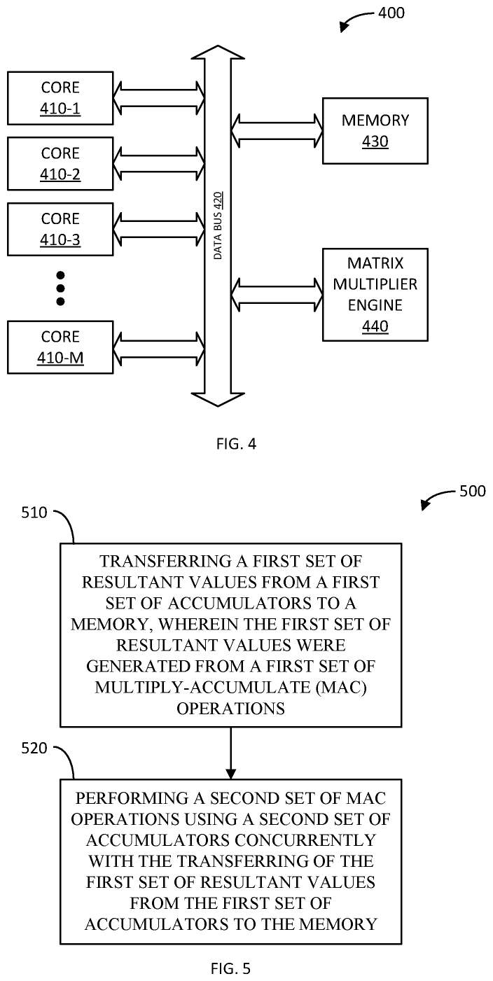

FIG. 4 illustrates a block diagram of an example multi-core integrated circuit (IC) 400 including a matrix multiplier engine 440 in accordance with another aspect of the disclosure. The IC 400 may be implemented as a silicon on chip (SOC) including a set of cores. The matrix multiplier engine 440 may be used in many different matrix multiplication applications.

In particular, the multi-core IC 400 include a set of processing cores 410-1 to 410-M, a memory 430, and the matrix multiplier engine 440, all data coupled together via a data bus 420. The set of processing cores 410-1 to 410-M may include a machine learning (ML) core, image processing cores, facial feature extraction core, object detection core, speech-to-text processing cores, and/or other or different set of cores. These data processing cores 410-1 to 410-M may share the matrix multiplier engine 440 and memory 430 for performing various matrix multiplication operations in furtherance of their respective functions/operations.

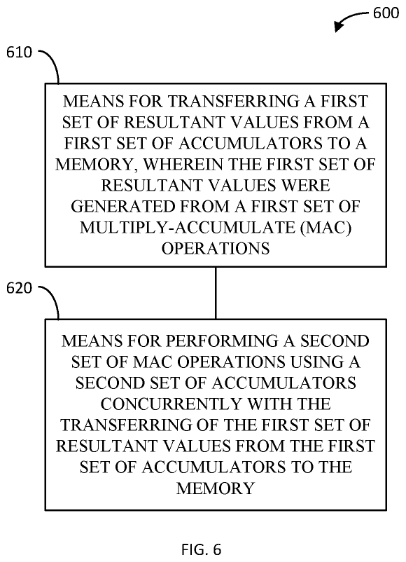

FIGS. 5-6 illustrate flow and block diagrams of an example method 500 of and apparatus 600 for performing matrix multiplication in accordance with another aspect of the disclosure. The method 500 includes transferring a first set of resultant values from a first set of accumulators to a memory, wherein the first set of resultant values were generated from a first set of multiply-accumulate (MAC) operations (block 510). Examples of means 610 for transferring a first set of resultant values from a first set of accumulators to a memory, wherein the first set of resultant values were generated from a first set of multiply-accumulate (MAC) operations include the controller 140, the matrix multiplier engines 100 and 440, and the memories 150 and 430.

The method 500 further includes performing a second set of MAC operations using a second set of accumulators concurrently with the transferring of the first set of resultant values from the first set of accumulators to the memory (block 520). Examples of means 620 for performing a second set of MAC operations using a second set of accumulators concurrently with the transferring of the first set of resultant values from the first set of accumulators to the memory include controller 140, the matrix multiplier engines 100 and 440, and the memories 150 and 430, an array of MAUs 210, and an array of MAUs 310.

Some of the components described herein may be implemented using a processor. A processor, as used herein, may be any dedicated circuit, processor-based hardware, a processing core of a system on chip (SOC), etc. Hardware examples of a processor may include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor may be coupled to memory (e.g., generally a computer-readable media or medium), such as a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

The following provides an overview of aspects of the present disclosure:
Aspect 1: An apparatus, including: a memory; a matrix multiplier engine coupled to the memory, comprising: an array of multiplier-accumulate units (MAUs) comprising: a first set of accumulators; and a second set of accumulators; and a controller coupled to the matrix multiplier engine and the memory, the controller configured to concurrently: cause a first set of resultant values in the first set of accumulators to be transferred to the memory pursuant to a first set of store instructions, wherein the first set of resultant values was generated pursuant to a first set of multiply-accumulate (MAC) operations performed by the set of multipliers and the first set of accumulators; and cause the set of multipliers and the second set of accumulators to perform a second set of MAC operations.
Aspect 2: The apparatus of aspect 1, wherein the first set of MAC operations precede the second set of MAC operations.
Aspect 3: The apparatus of aspect 1 or 2, wherein the controller is configured to select the second set of accumulators for the second set of MAC operations in response to a demarcation instruction.
Aspect 4: The apparatus of aspect 3, wherein the demarcation instruction comprises an instruction to zero the first set of accumulators.
Aspect 5: The apparatus of aspect 3 or 4, wherein the array of MAUs comprise a set of demultiplexers including a first set of inputs coupled to the set of multipliers, a first set of outputs coupled to the first set of accumulators, and a second set of outputs coupled to the second set of accumulators, wherein the controller is configured to select the second set of accumulators by sending a control signal to a set of select inputs of the set of demultiplexers, respectively.
Aspect 6: The apparatus of any one of aspects 3-5, wherein the demarcation instruction indicates that the second set of MAC operations is independent of the first set of MAC operations.
Aspect 7: The apparatus of any one of aspects 3-6, wherein the controller is configured to: cause the set of multipliers and the first set of accumulators to perform the first set of MAC operations in response to a first set of MAC instructions; and cause the set of multipliers and the second set of accumulators to perform the second set of MAC operations in response to a second set of MAC instructions, wherein the demarcation instruction is sequentially situated between the first set of store instructions and the second set of MAC instructions.
Aspect 8: The apparatus of aspect 7, wherein the controller is configured to look ahead for the demarcation instruction to cause the concurrent transfer of the first set of resultant values to the memory and the second set of MAC operations.
Aspect 9: The apparatus of any one of aspects 1-8, wherein the second set of MAC operations generates a second set of resultant values held in the second set of accumulators, respectively.
Aspect 10: The apparatus of aspect 9, wherein the second set of resultant values are generated prior to the first set of resultant values being completely transferred to the memory.
Aspect 11: The apparatus of aspect 10, wherein the array of MAUs further comprise a third set of accumulators, wherein the controller is configured to concurrently: continue the first set of resultant values to be transferred to the memory; and cause the set of multipliers and the third set of accumulators to perform a third set of MAC operations. Aspect 12: The apparatus of aspect 11, wherein the controller is configured to select the third set of accumulators for the third set of MAC operations in response to a demarcation instruction.
Aspect 13: The apparatus of aspect 12, wherein the demarcation instruction comprises an instruction to zero the second set of accumulators.
Aspect 14: The apparatus of aspect 12 or 13, wherein the array of MAUs comprise a set of demultiplexers including a first set of inputs coupled to the set of multipliers, a first set of outputs coupled to the first set of accumulators, a second set of outputs coupled to the second set of accumulators, and a third set of outputs coupled to the third set of accumulators, wherein the controller is configured to select the third set of accumulators by sending a control signal to a set of select inputs of the set of demultiplexers, respectively.
Aspect 15: The apparatus of any one of aspects 12-14, wherein the demarcation instruction indicates that the third set of MAC operations is independent of the second set of MAC operations.
Aspect 16: The apparatus of any one of aspects 12-15, wherein the controller is configured to: cause the set of multipliers and the second set of accumulators to perform the second set of MAC operations in response to a second set of MAC instructions; and cause the set of multipliers and the third set of accumulators to perform the third set of MAC operations in response to a third set of MAC instructions, wherein the demarcation instruction is sequentially situated between the second set of store instructions and the third set of MAC instructions.
Aspect 17: The apparatus of claim 11, wherein the controller is configured to concurrently: continue to cause the set of multipliers and the third set of accumulators to perform the third set of MAC operations; and cause the second set of resultant values to be transferred to the memory.
Aspect 18: The apparatus of aspect 9, wherein the controller configured to concurrently: cause the second set of resultant values to be transferred to the memory pursuant to a second set of store instructions; and cause the set of multipliers and the first set of accumulators to perform a third set of MAC operations.
Aspect 19: The apparatus of aspect 18, wherein the second set of MAC operations precede the third set of MAC operations.
Aspect 20: The apparatus of aspect 18 or 19, wherein the controller is configured to select the first set of accumulators for the third set of MAC operations in response to a demarcation instruction.
Aspect 21: The apparatus of aspect 20, wherein the demarcation instruction comprises an instruction to zero the second set of accumulators.
Aspect 22: The apparatus of aspect 20 or 21, wherein the demarcation instruction indicates that the third set of MAC operations is independent of the second set of MAC operations.
Aspect 23: The apparatus of any one of aspects 20-22, wherein the controller is configured to cause the set of multipliers and the first set of accumulators to perform the third set of MAC operations in response to a third set of MAC instructions, wherein the demarcation instruction is sequentially situated between the second set of store instructions and the third set of MAC instructions.
Aspect 24: The apparatus of aspect 23, wherein the controller is configured to look ahead for the demarcation instruction to cause the concurrent transfer of the second set of resultant values to the memory and the third set of MAC operations.
Aspect 25: The apparatus of any one of aspects 18-24, wherein the array of MAUs comprise a set of demultiplexers including a first set of inputs coupled to the set of multipliers, a first set of outputs coupled to the first set of accumulators, and a second set of outputs coupled to the second set of accumulators, wherein the controller is configured to select the first set of accumulators by sending a control signal to a set of select inputs of the set of demultiplexers, respectively.
Aspect 26: A method of performing matrix multiplication, comprising: transferring a first set of resultant values from a first set of accumulators to a memory, wherein the first set of resultant values were generated from a first set of multiply-accumulate (MAC) operations; and performing a second set of MAC operations using a second set of accumulators concurrently with the transferring of the first set of resultant values from the first set of accumulators to the memory.
Aspect 27: The method of aspect 26, further comprising selecting the second set of accumulators for performing the second set of MAC operations based on a demarcation instruction indicating that the second set of MAC operations is independent of the first set of MAC operations.
Aspect 28: The method of aspect 26 or 27, wherein performing the second set of MAC operations generates a second set of resultant values in the second set of accumulators, respectively.
Aspect 29: The method of aspect 28, wherein the second set of resultant values are generated prior to completion of the transfer of the first set of resultant values to the memory, and further comprising performing a third set of MAC operations using a third set of accumulators concurrently with the continue transferring of the first set of resultant values to the memory.
Aspect 30: An apparatus, comprising: means for transferring a first set of resultant values from a first set of accumulators to a memory, wherein the first set of resultant values were generated from a first set of multiply-accumulate (MAC) operations; and means for performing a second set of MAC operations using a second set of accumulators concurrently with the transferring of the first set of resultant values from the first set of accumulators to the memory.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. An apparatus, comprising:
a memory;
a matrix multiplier engine coupled to the memory, comprising:
an array of multiplier-accumulate units (MAUs) comprising:
a set of multipliers;
a first set of accumulators; and
a second set of accumulators; and
a controller coupled to the matrix multiplier engine and the memory, the controller configured to concurrently:
cause a first set of resultant values in the first set of accumulators to be transferred to the memory pursuant to a first set of store instructions, wherein the first set of resultant values was generated pursuant to a first set of multiply-accumulate (MAC) operations performed by the set of multipliers and the first set of accumulators; and
cause the set of multipliers and the second set of accumulators to perform a second set of MAC operations.

2. The apparatus of claim 1, wherein the first set of MAC operations precede the second set of MAC operations.

3. The apparatus of claim 1, wherein the controller is configured to select the second set of accumulators for the second set of MAC operations in response to a demarcation instruction.

4. The apparatus of claim 3, wherein the demarcation instruction comprises an instruction to zero the first set of accumulators.

5. The apparatus of claim 3, wherein the array of MAUs comprise a set of demultiplexers including a first set of inputs coupled to the set of multipliers, a first set of outputs coupled to the first set of accumulators, and a second set of outputs coupled to the second set of accumulators, wherein the controller is configured to select the second set of accumulators by sending a control signal to a set of select inputs of the set of demultiplexers, respectively.

6. The apparatus of claim 3, wherein the demarcation instruction indicates that the second set of MAC operations is independent of the first set of MAC operations.

7. The apparatus of claim 3, wherein the controller is configured to:
cause the set of multipliers and the first set of accumulators to perform the first set of MAC operations in response to a first set of MAC instructions; and
cause the set of multipliers and the second set of accumulators to perform the second set of MAC operations in response to a second set of MAC instructions, wherein the demarcation instruction is sequentially situated between the first set of store instructions and the second set of MAC instructions.

8. The apparatus of claim 7, wherein the controller is configured to look ahead for the demarcation instruction to cause the concurrent transfer of the first set of resultant values to the memory and the second set of MAC operations.

9. The apparatus of claim 1, wherein the second set of MAC operations generates a second set of resultant values held in the second set of accumulators, respectively.

10. The apparatus of claim 9, wherein the second set of resultant values are generated prior to the first set of resultant values being completely transferred to the memory.

11. The apparatus of claim 10, wherein the array of MAUs further comprise a third set of accumulators, wherein the controller is configured to concurrently:
continue the first set of resultant values to be transferred to the memory; and
cause the set of multipliers and the third set of accumulators to perform a third set of MAC operations.

12. The apparatus of claim 11, wherein the controller is configured to select the third set of accumulators for the third set of MAC operations in response to a demarcation instruction.

13. The apparatus of claim 12, wherein the demarcation instruction comprises an instruction to zero the second set of accumulators.

14. The apparatus of claim 12, wherein the array of MAUs comprise a set of demultiplexers including a first set of inputs coupled to the set of multipliers, a first set of outputs coupled to the first set of accumulators, a second set of outputs coupled to the second set of accumulators, and a third set of outputs coupled to the third set of accumulators, wherein the controller is configured to select the third set of accumulators by sending a control signal to a set of select inputs of the set of demultiplexers, respectively.

15. The apparatus of claim 12, wherein the demarcation instruction indicates that the third set of MAC operations is independent of the second set of MAC operations.

16. The apparatus of claim 12, wherein the controller is configured to:
cause the set of multipliers and the second set of accumulators to perform the second set of MAC operations in response to a second set of MAC instructions; and
cause the set of multipliers and the third set of accumulators to perform the third set of MAC operations in response to a third set of MAC instructions, wherein the demarcation instruction is sequentially situated between a second set of store instructions and the third set of MAC instructions.

17. The apparatus of claim 11, wherein the controller is configured to concurrently:
continue to cause the set of multipliers and the third set of accumulators to perform the third set of MAC operations; and
cause the second set of resultant values to be transferred to the memory.

18. The apparatus of claim 9, wherein the controller configured to concurrently:
cause the second set of resultant values to be transferred to the memory pursuant to a second set of store instructions; and
cause the set of multipliers and the first set of accumulators to perform a third set of MAC operations.

19. The apparatus of claim 18, wherein the second set of MAC operations precede the third set of MAC operations.

20. The apparatus of claim 18, wherein the controller is configured to select the first set of accumulators for the third set of MAC operations in response to a demarcation instruction.

21. The apparatus of claim 20, wherein the demarcation instruction comprises an instruction to zero the second set of accumulators.

22. The apparatus of claim 20, wherein the demarcation instruction indicates that the third set of MAC operations is independent of the second set of MAC operations.

23. The apparatus of claim 20, wherein the controller is configured to cause the set of multipliers and the first set of accumulators to perform the third set of MAC operations in response to a third set of MAC instructions, wherein the demarcation instruction is sequentially situated between the second set of store instructions and the third set of MAC instructions.

24. The apparatus of claim 23, wherein the controller is configured to look ahead for the demarcation instruction to cause the concurrent transfer of the second set of resultant values to the memory and the third set of MAC operations.

25. The apparatus of claim 18, wherein the array of MAUs comprise a set of demultiplexers including a first set of inputs coupled to the set of multipliers, a first set of outputs coupled to the first set of accumulators, and a second set of outputs coupled to the second set of accumulators, wherein the controller is configured to select the first set of accumulators by sending a control signal to a set of select inputs of the set of demultiplexers, respectively.

26. A method of performing matrix multiplication, comprising:
transferring a first set of resultant values from a first set of accumulators to a memory, wherein the first set of resultant values were generated from a first set of multiply-accumulate (MAC) operations; and
performing a second set of MAC operations using a second set of accumulators concurrently with the transferring of the first set of resultant values from the first set of accumulators to the memory.

27. The method of claim 26, further comprising selecting the second set of accumulators for performing the second set of MAC operations based on a demarcation instruction indicating that the second set of MAC operations is independent of the first set of MAC operations.

28. The method of claim 26, wherein performing the second set of MAC operations generates a second set of resultant values in the second set of accumulators, respectively.

29. The method of claim 28, wherein the second set of resultant values are generated prior to completion of the transfer of the first set of resultant values to the memory, and further comprising performing a third set of MAC operations using a third set of accumulators concurrently with the continue transferring of the first set of resultant values to the memory.

30. An apparatus, comprising:
means for transferring a first set of resultant values from a first set of accumulators to a memory, wherein the first set of resultant values were generated from a first set of multiply-accumulate (MAC) operations; and
means for performing a second set of MAC operations using a second set of accumulators concurrently with the transferring of the first set of resultant values from the first set of accumulators to the memory.
